(19) United States
(12) Patent Application Publication
(10) Pub. No.: US 2026/0371195 A1
(43) Pub. Date: Nov. 19, 2026

(54) Terminal, System, and Method for Performing a Dynamic Switching Procedure

(71) Applicant: Apple Inc., Cupertino, CA (US)

(72) Inventors: Sigen Ye, San Diego, CA (US); Peng Cheng, Beijing (CN); Wei Zeng, Saratoga, CA (US); Ankit Bhamri, Haar (DE); Seyed Ali Akbar Fakoorian, San Diego, CA (US); Dawei Zhang, Saratoga, CA (US); Huaning Niu, San Jose, CA (US); Oghenekome Oteri, San Diego, CA (US)

(21) Appl. No.: 19/127,077

(22) PCT Filed: Nov. 5, 2022
(86) PCT No.: PCT/CN2022/130156

§ 371 Date: May 2, 2025

(51) Int. Cl. H04W 36/08; H04L 5/00; H04W 72/02; H04W 72/21; H04W 72/231

(52) U.S. Cl. CPC H04W 36/08; H04L 5/0053; H04W 72/02; H04W 72/21; H04W 72/231

(57) ABSTRACT

A terminal may include a receiver configured to receive information parameters indicating a dynamic switching of a primary cell from a source cell to a target cell. The information parameters may be received in a specific downlink control information (DCI) format. The terminal may include a processor configured to determine an application delay that indicates a starting time of the dynamic switching. The processor may use the target cell as the primary cell at the starting time.

### FIELD

The present application relates to wireless devices and wireless networks, including devices, circuits, and methods for performing a dynamic switching procedure.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

### SUMMARY

In accordance with one or more embodiments, a terminal includes a receiver configured to receive information parameters indicating a dynamic switching of a primary cell from a source cell to a target cell. The information parameters are received in a specific downlink control information (DCI) format. The terminal includes a processor configured to determine an application delay that indicates a starting time of the dynamic switching. The processor uses the target cell as the primary cell at the starting time.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a BS, according to some aspects.

FIG. 4 illustrates an example block diagram of wireless communication circuitry, according to some aspects.

FIG. 5 is a diagram illustrating an example of signaling format techniques in a dynamic switching procedure, according to some aspects.

FIG. 6 is a diagram illustrating an example of signaling format techniques in the dynamic switching procedure, according to some aspects.

FIGS. 7A and 7B are diagrams illustrating an example of signaling techniques including an acknowledgement signal in the dynamic switching procedure, according to some aspects.

FIGS. 8A and 8B are diagrams illustrating an example of signaling techniques including a change of status on a source cell in the switching procedure, according to some aspects.

FIG. 9 is a flowchart detailing a method of performing the dynamic switching procedure, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study enhancements to network energy saving in mobile services and mobile devices. The evolution of the 5G and New Radio (NR) standards need to continuously improve energy network efficiency and energy savings for user equipment (UE) devices and base station (BS) devices. Improvements are needed in terms of both transmission and reception procedures.

In one or more embodiments described herein, improvements are made to efficient operation of dynamically and/or semi-statically reception/transmission changes in wireless communications. Further, improvement are made to these communications by providing finer granularity adaptation of transmissions and/or receptions in one or more of network energy saving techniques in time, frequency, spatial, and power domains. The improvements are made for these communications between UE devices and BS devices. In some embodiments, the improvements in the BS devices include potential support/feedback from UE devices, and potential UE device assistance information (i.e., in layer 1 and/or layer 2 applications). Further, improvements may be made in information exchange/coordination procedures over network interfaces (i.e., in layer 3 applications).

In some embodiments, the improvements are made to mechanisms for performing dynamic switching of a primary cell by signaling details for indicating dynamic switching of the primary cell; acknowledging the dynamic indication, configuring an application delay, and determining whether an SCell is placed in dormancy or deactivation after the switching procedure is performed.

In accordance with one or more embodiments, the UE device or terminal communicates with other terminals (other wireless communication devices, network devices, UE devices, and/or BS devices) may perform radio transmissions including existing energy saving mechanisms and techniques. In some embodiments, the term “primary cell” may be any SpCell (i.e., special cell), which may be either the i.e., the Primary Cell (PCell) or the PSCell of the Secondary Cell Group (SCG) in case of 5G NR dual-connectivity. Further, the term “source cell” may refer to the primary cell before the switching and the term “target cell” may refer to the primary cell after the switching procedure. In these embodiments, the dynamic indication indicates the UE device to switch from a first cell to a second cell. In these cases, the first cell may be the source cell, and the second cell may be the target cell. The source cell and the target cell may be referred to as a “source primary cell” and a “target primary cell,” respectively.

The following is a glossary of terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™) Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

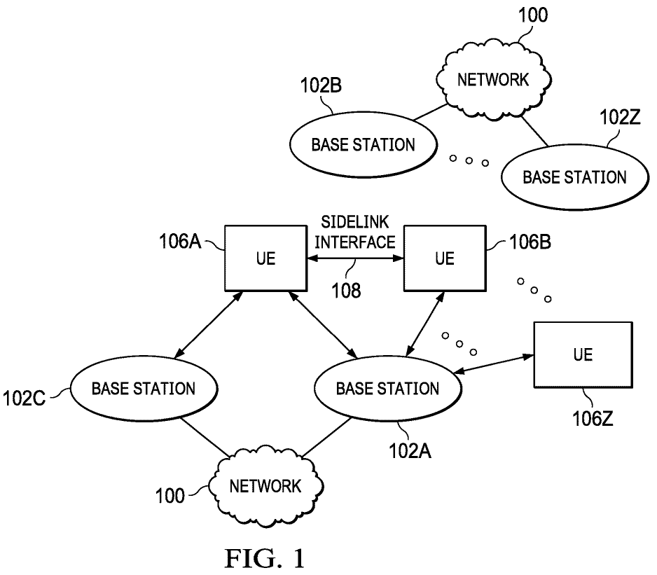

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weatherpr23 enclosure suitable for outdoor installation, and may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### L1 Group Common Signaling for Primary Cell Switching

As described above, in some embodiments described herein, energy savings are enhanced during network communications. Specifically, energy savings are enhanced in communication exchanges between the base stations 102 and the UEs 106. In some embodiments, transmission and reception between the base stations 102 and the UEs 106 are improved by achieving more efficient operation dynamically and/or semi-statically and finer granularity adaptation of transmissions and/or receptions in one or more of network energy saving techniques.

In the dynamic cell switching procedures described herein, one of the UEs 106 replaces a primary cell using a specific DCI format optimized to increase energy savings. Upon performing the dynamic cell switching procedure, the source cell is determined to be an active source cell, a deactivated source cell, or a dormant cell. Activation, deactivation, and/or dormancy are all states of the source cell from the perspective of the UE performing the dynamic cell switching procedure. The source cell may remain an activated source cell if information parameters indicate transition the source cell into a secondary cell (SCell) to generate or relay signaling between the base stations 102 and the UEs 106. The source cell may become a deactivated source cell if information parameters indicate transition the source cell away from generating or relaying signaling between the base stations 102 and the UEs 106. The source cell may be considered dormant if information parameters indicate that the source cell may remain in a dormant state. In the dormant state, the source cell may stop monitoring operations for the UE, but continues performing CSI measurements, Automatic Gain Control (AGC) and beam management, if configured. Information parameters indicating activation, deactivation, and/or dormancy states may be provided via Radio Resource Control (RRC) signaling or Medium Access Control (MAC)-Control Element (CE) from the network 100.

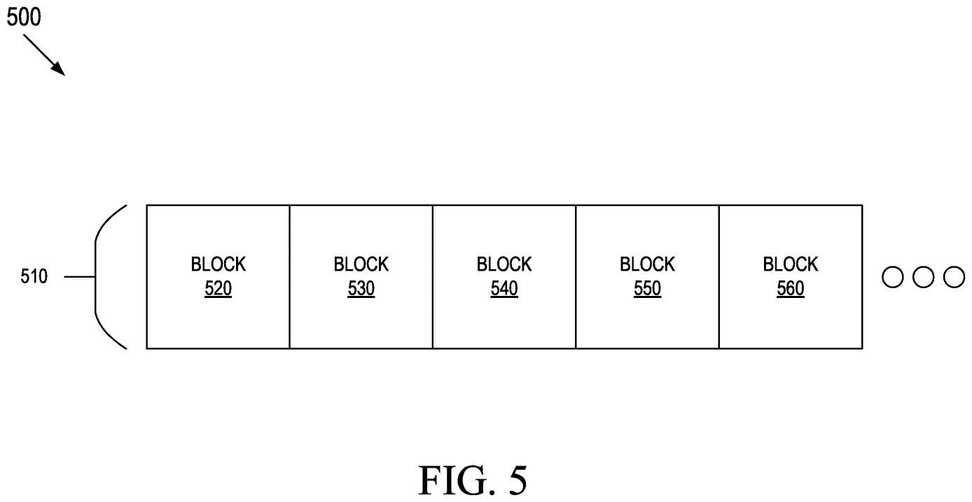

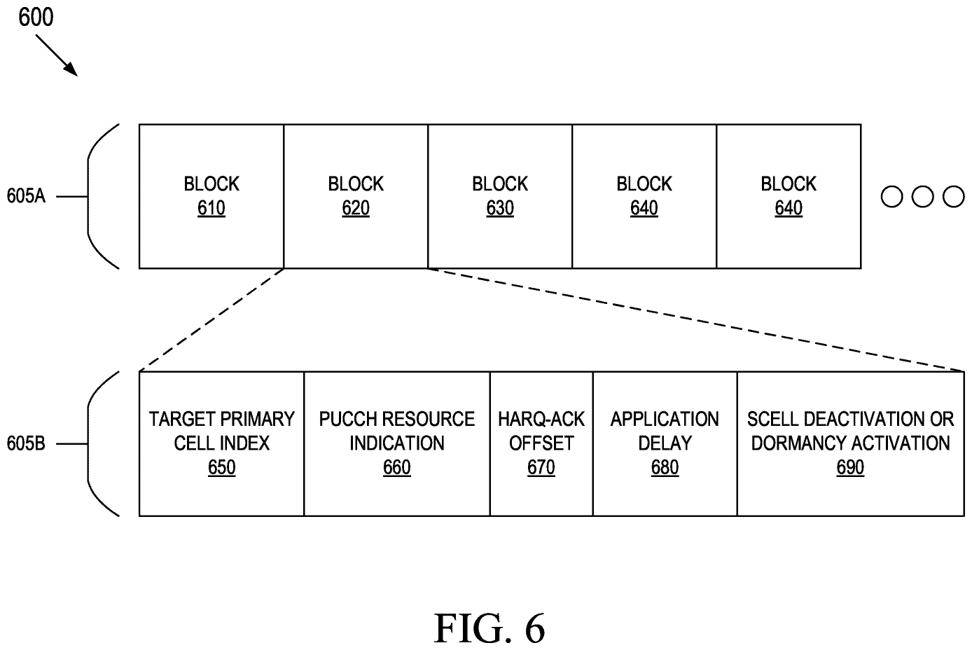

In one or more embodiments, as a non-limiting example, the UE 106A may include a receiver configured to receive information parameters from one of the base stations 102. The information parameters may indicate a dynamic switching of a primary cell from a source cell in the UE 106B to a target cell in one of the UEs 106C-106Z. The information parameters may be received in a specific DCI format The specific DCI format may be an existing DCI format or a format adapted for this implementation as it will be described in reference to FIGS. 5 and 6. Upon receiving the information parameters, the UE 106A may determine an application delay that indicates a starting time of the dynamic switching, perform the dynamic switching at the starting time, and identify the source cell as a deactivated cell or a dormant cell.

In some embodiments, a first DCI format includes multiple information blocks carrying information related to the primary cell switching for the UE 106A and at least one additional primary cell switching for another UE 106. In this case, multiple UEs are instructed to perform dynamic switching of the primary cell. A second DCI format may include one information block carrying information related to the primary cell switching for the UE 106A.

Each information block in the DCI may include a primary cell index providing an identity for the source cell and/or the target cell, a Physical Uplink Control Channel (PUCCH) resource indication used for acknowledging that the information parameters were received by the UE 106A, a time offset for transmission of the PUCCH to indicate that the UE 106 performs the dynamic switching procedure uninterrupted, and/or an indication of the application delay.

The dynamic cell switching procedures described herein may be additionally performed using information elements and/or signaling described in 3GPP TS 38.212, TS 38.214, TS 38.215, TS 38.321, and TS 38.331.

### Example Communication Device

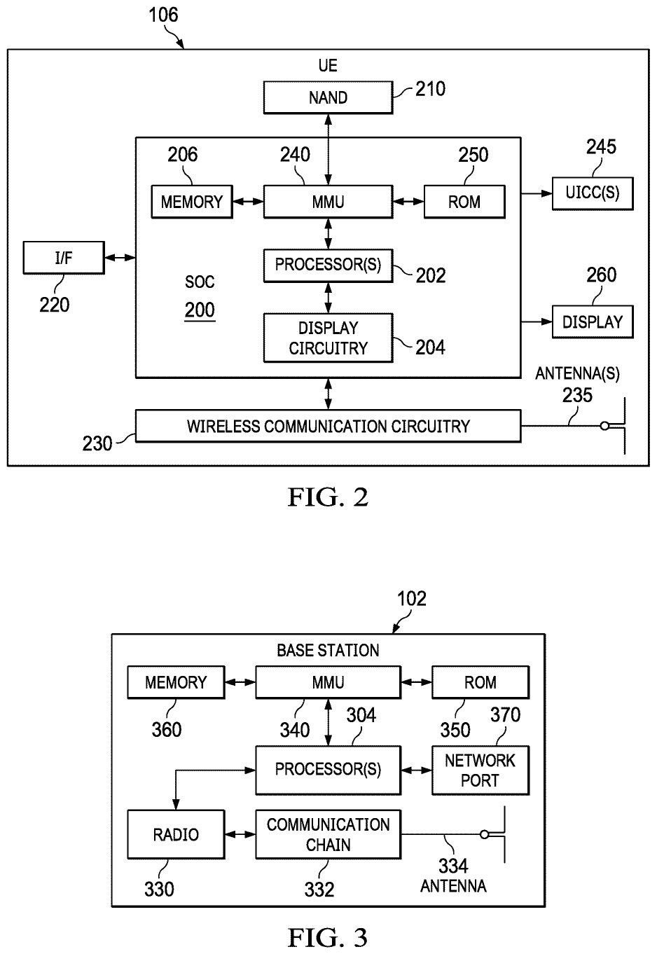

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

FIG. 3 illustrates an example block diagram of a base station 102, according to some aspects. It is noted that the base station of FIG. 3 is a non-limiting example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 304 of the base station 102 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

### Example Cellular Communication Circuitry

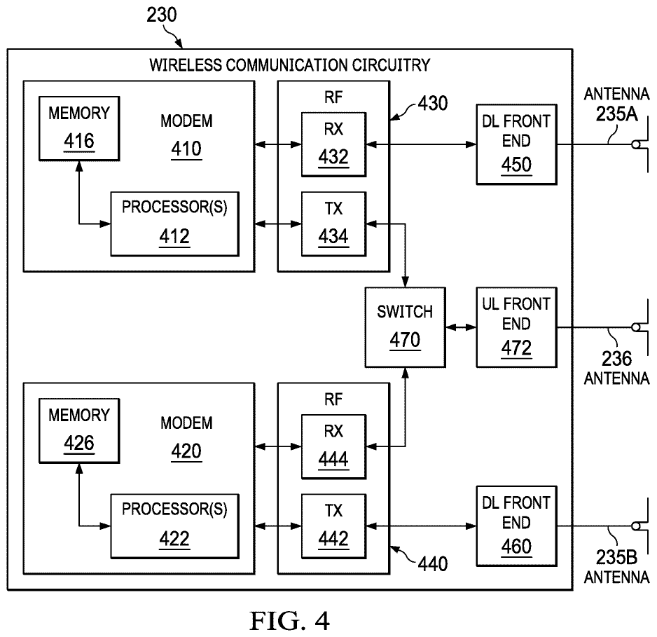

FIG. 4 illustrates an example simplified block diagram of cellular communication circuitry, according to some aspects. It is noted that the block diagram of the cellular communication circuitry of FIG. 4 is only one example of a possible cellular communication circuit; other circuits, such as circuits including or coupled to sufficient antennas for different RATs to perform uplink activities using separate antennas, or circuits including or coupled to fewer antennas (e.g., that may be shared among multiple RATs) are also possible. According to some aspects, cellular communication circuitry 230 may be included in a communication device, such as communication device 106 described above. As noted above, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 230 may couple (e.g., communicatively; directly or indirectly) to one or more antennas, such as antennas 235a, 235b, and 236 as shown. In some aspects, cellular communication circuitry 230 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 4, cellular communication circuitry 230 may include a first modem 410 and a second modem 420. The first modem 410 may be configured for communications according to a first RAT, e.g., such as LTE or LTE-A, and the second modem 420 may be configured for communications according to a second RAT, e.g., such as 5G NR.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some aspects, receive circuitry 432 may be in communication with downlink (DL) front end 450, which may include circuitry for receiving radio signals via antenna 235a.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some aspects, receive circuitry 442 may be in communication with DL front end 460, which may include circuitry for receiving radio signals via antenna 235b.

In some aspects, a switch 470 may couple transmit circuitry 434 to uplink (UL) front end 472. In addition, switch 470 may couple transmit circuitry 444 to UL front end 472. UL front end 472 may include circuitry for transmitting radio signals via antenna 236. Thus, when cellular communication circuitry 230 receives instructions to transmit according to the first RAT (e.g., as supported via the first modem 410), switch 470 may be switched to a first state that allows the first modem 410 to transmit signals according to the first RAT (e.g., via a transmit chain that includes transmit circuitry 434 and UL front end 472). Similarly, when cellular communication circuitry 230 receives instructions to transmit according to the second RAT (e.g., as supported via the second modem 420), switch 470 may be switched to a second state that allows the second modem 420 to transmit signals according to the second RAT (e.g., via a transmit chain that includes transmit circuitry 444 and UL front end 472).

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 450, 470, 472, 235 and 236 may be configured to implement part or all of the features described herein.

In addition, as described herein, processors 412, 422 may include one or more processing elements. Thus, processors 412, 422 may include one or more integrated circuits (ICs) that are configured to perform the functions of processors 412, 422. In addition, each integrated circuit may include circuitry (e.g., first circuitry, second circuitry, and the like) configured to perform the functions of processors 412, 422.

In some aspects, the cellular communication circuitry 230 may include only one transmit/receive chain. For example, the cellular communication circuitry 230 may not include the modem 420, the RF front end 440, the DL front end 460, and/or the antenna 235b. As another example, the cellular communication circuitry 230 may not include the modem 410, the RF front end 430, the DL front end 450, and/or the antenna 235a. In some aspects, the cellular communication circuitry 230 may also not include the switch 470, and the RF front end 430 or the RF front end 440 may be in communication, e.g., directly, with the UL front end 472.

Turning to FIG. 5, a diagram 500 shows primary cell switching indications for one or more terminals (i.e., UEs 106) that are carried in a common DCI 510. This DCI 510 is shown to include multiple blocks 520-560 including multiple information parameters. Padding bits may be appended at the end of the DCI to reach a specific DCI size. In some embodiments, the DCI 510 may be a specific DCI format including the multiple blocks 520-560 of information. Each block may include the information related to a primary cell switching for a corresponding terminal.

In some embodiments, the specific DCI format may be configured on one or more serving cells for the terminal. The specific DCI format may include the overall structure and content definitions from information elements described in reference to 3GPP TS 38.212.

The specific DCI may include a format that is adjusted specifically for dynamic primary cell switching. In this format, the terminal may be configured with a block including a corresponding Radio Network Temporary Identifier (RNTI) value for the DCI, a DCI size, a search space set configuration to monitor the DCI, and a starting position of the block within the DCI. The RNTI may be used to differentiate/identify a connected terminal in the serving cell, a specific radio channel, a group of terminals in case of paging, a group of terminals for which power control is issued by a base station or another terminal, system information transmitted for all the terminals in a broadcasted signal, and/or a group of terminals to monitor the DCI for dynamic primary switching here. If not specifically configured, the DCI size may be the same as the DCI size of format 1_0 monitored in common search space in the same serving cell. The search space set may be configured reusing the existing search space set configuration structure.

The specific DCI may include a format that is a modified version of an existing DCI. The modified version may be incorporated into one or more of the existing group common DCI formats described in 3GPP TS 38.212. For example, if the primary cell switching indication is incorporated into DCI format 2_2 (i.e., for the transmission of TPC commands for Physical Uplink Control Channel (PUCCH) and Physical Uplink Shared Channel (PUSCH)), each block in the DCI may be either a legacy bock that carries the Transmit Power Control (TPC) command for PUSCH or PUCCH for a UE, or a block that carries the information related to a primary cell switching for a terminal. In some embodiments, the legacy bock that carries the TPC command for PUSCH or PUCCH and the block that carries the information related to the primary cell switching for the same terminal may be carried in the same DCI, with different starting position in the DCI.

In the aforementioned example of using DCI format 2_2, the terminal may reuse the configuration of the existing DCI format such as the RNTI, the DCI size, and the search space set configuration to determine when and where to monitor the DCI. Further, the terminal may be configured with the starting position of the block within the DCI to monitor the primary cell switching indication.

If multiple existing DCI formats are supported to carry the primary cell switching indication, the terminal may be configured with individual DCI formats out of the existing DCI formats available.

In one or more embodiments, the terminal may be configured to monitor the DCI on one or more serving cells. If a serving cell becomes dormant or deactivated, the terminal may not monitor the DCI on the serving cell, following the existing terminal behavior. In some embodiments, a terminal may be configured with one or more search space sets for monitoring the DCI on all the candidate cells for the primary cell switching. In this regard, the terminal may monitor the DCI on the current primary cell, and may not monitor the DCI on all the other candidate cells.

In FIG. 6, a diagram 600 includes a DCI format 605A and an example content of a block of 605A in 605B. In DCI format 605A, blocks 610-640 may be configured in accordance with any one of the specific DCI formats described in reference to FIG. 5. A block 605B may represent the contents in one of blocks 610-640. For example, the block 620 may carry the primary cell switching indication for the terminal. The block 620 may include a target primary cell index 650, a PUCCH resource indication 660 for HARQ-ACK for the indication, a HARQ-ACK offset 670 for the indication, an application delay 680 indication, and an SCell deactivation or dormancy activation 690 indication.

In one or more embodiments, the target primary cell index 650 is the index of the target primary cell. If the index is the same as the current primary cell, the terminal does not take any action; otherwise, the terminal switches the primary cell to the cell corresponding to the indicated index. In some embodiments, the primary cell index may no longer always 0 (i.e., in a legacy system, the index of the primary cell may always be 0).

In one or more embodiments, the primary cell index supported may be a non-zero index for the primary cell in general. In this regard, the primary cell index may include adding explicit indication for the primary cell in serving cell configuration, and removing some implicit assumption that cell index 0 always corresponds to the primary cell. In some embodiments, the primary cell index supported may be a non-zero index for primary cell only for a short transition period. In this regard, if the dynamic DCI indicates the primary cell switching to a cell with non-zero index, a high layer signaling (i.e., RRC signaling or MAC CE) is used to re-assign the cell indexes for both source and target primary cell, such that the target primary cell has an index of 0.

In one or more embodiments, the primary cell index change occurs together with the primary cell switching, and the primary cell in use always has index of 0. Each candidate for the primary cell may be configured with a non-zero cell index. In this case, if a candidate cell becomes the primary cell, it may use index 0; otherwise it may use the configured non-zero cell index. Further, in this case, an explicit configuration is necessary to indicate the primary cell at the initial configuration.

A non-zero cell index may be explicitly indicated inside the block 620. After the switching, the target primary cell may have an index 0, and the source primary cell may use the indicated cell index. Further, the source primary cell and target primary cell may also switch the cell indexes together with primary cell switching.

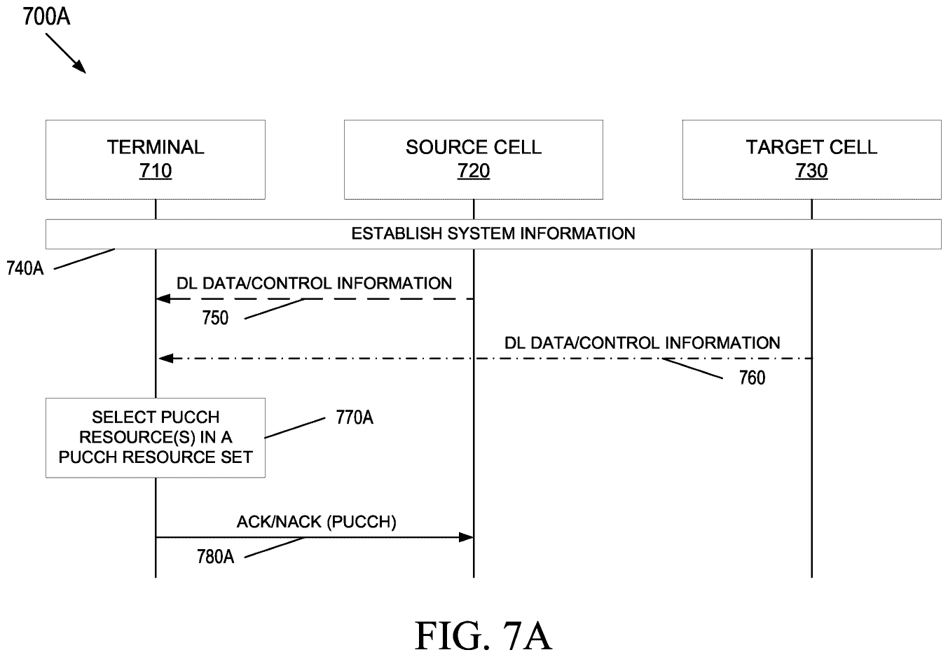

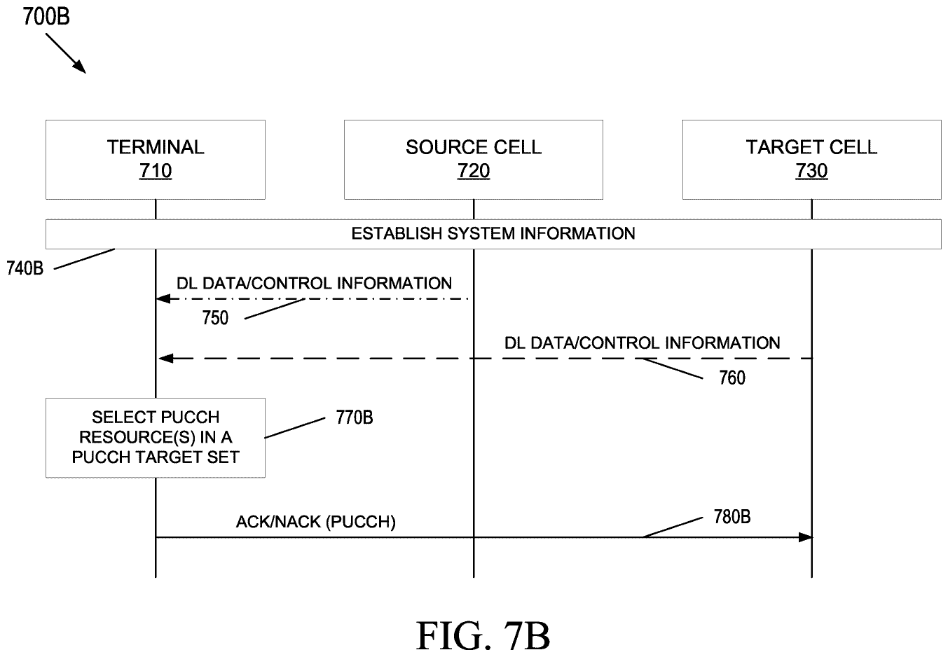

Turning to FIGS. 7A and 7B, signal diagrams 700A and 700B illustrate multiple signal exchanges in the process of providing a dynamic cell switching command to a terminal 710. In the signal diagrams 700A and 700B, the source cell 720 and the target cell 730 are connected to the terminal 710 via an established system information. In the examples of FIGS. 7A and 7B, a transmitter in the terminal 710 may be configured to transmit, to the source cell or the target cell, an indication acknowledging that information parameters were received via DL data/control information 750 received from the source cell 720 or DL data/control information 760 received from the target cell 730. The indication acknowledging that the information parameters were received may be transmitted in a PUCCH configured for the source cell as shown in FIG. 7A or a PUCCH configured for the target cell as shown in FIG. 7B.

In the examples of FIGS. 7A and 7B, the terminal 710, the source cell 720, and the target cell 730 establish system information 740 (i.e., individually labeled 740A and 740B in FIGS. 7A and 7B, respectively), where the source cell 720 or the target cell 730 indicate a specific resource allocation to the terminal 710. The system information 740 may include information used to configure data/control transmissions between the terminal 710 and multiple primary cells. For example, the system information 740 may indicate that one of the source cell 720 and the target cell are configured to transmit a DCI indicating the dynamic cell switching.

Further, the source cell 720 and/or the target cell 730 may provide the terminal 710 with a DCI transmission in one of the formats discussed in reference to FIGS. 5 and/or 6. In some embodiments, the source cell 720 transmits a DL data/control information 750 to the terminal 710. In other embodiments, the target cell 730 transmits a DL data/control information 760 to the terminal 710. In some other embodiments (not shown in FIG. 7A or 7B), a cell other than the source cell 720 or target cell 730 transmits a DL data/control information 760 to the terminal 710. Notwithstanding whether the terminal 710 receives the DL data/control information 750 or DL data/control information 760, the terminal receives the specific resource allocation to configure the PUCCH.

In FIG. 7A, the terminal 710, the source cell 720, and the target cell 730 establish system information 740A. Further, the DL data/control information 750 from the source cell 720 and/or the DL data/control information 760 from the target cell 730 may provide the terminal with a configuration to select PUCCH resources in a PUCCH source set, as shown in block 770A. After the resources for the PUCCH is selected by the terminal 710, the terminal 710 provides the ACK/NACK (PUCCH) signal 780A.

In FIG. 7B, the terminal 710, the source cell 720, and the target cell 730 establish system information 740B. Further, the DL data/control information 750 from the source cell 720 and/or the DL data/control information 760 from the target cell 730 may provide the terminal with a configuration to select PUCCH resources in a PUCCH target set, as shown in block 770B. After the resources for the PUCCH is selected by the terminal 710, the terminal 710 provides the ACK/NACK (PUCCH) signal 780B.

In one or more embodiments, the examples of FIGS. 7A and 7B prevent a missed detection of the primary cell switching indication at the terminal 710. In this regard, the acknowledgement indication prevents different understanding of the primary cell switching procedure between any base stations communicating with the source cell 720 and the target cell 730 and the terminal 710. As shown in FIGS. 7A and 7B, the acknowledgement may be transmitted using physical layer signaling (i.e., HARQ-ACK on PUCCH). As shown above, the acknowledgement indication may be transmitted on PUCCH on the source cell 720 or the PUCCH on the target cell. In these cases, the terminal may be configured or indicated with a PUCCH resource and a time offset for the HARQ-ACK. Further, the PUCCH resource may be configured or indicated via a PUCCH resource index. In some embodiments, the PUCCH resource or the time offset for HARQ-ACK may be (pre-)configured, pre-defined in the specifications, semi-statically configured via RRC signaling, or dynamically indicated in the DCI as part of the block information that carries the primary cell switching indication, as shown in FIGS. 5 and 6.

### Application Delay

In one or more embodiments, the terminal 720 may be configured with a set of candidate cells for primary cell dynamic switching. The target cell 730 may be restricted to an active serving cell, or an active and non-dormant serving cell. In some embodiments, there may be no such restriction at all, but the application delay may depend on the status of the target primary cell, as explained below.

The application delay may define a starting time for the terminal 710 to use the target cell 730 as the primary cell. The application delay may be used by the terminal 710 to prepare for and complete the primary cell switching procedure. A reference time for the application delay may be a time when the group common DCI is transmitted, or when an acknowledgement is transmitted. In some embodiments, the application delay may be defined as an offset relative to the reference time. The unit may be the number of symbols/slots or absolute time such as milliseconds.

In some embodiments, the application delay may be dependent on a subcarrier spacing (SCS). The SCS is an entity which connects to the 3GPP network to communicate with terminals used for MTC in a Home Public Land Mobile Network (HPLMN). The SCS offers capabilities for use by one or multiple MTC Applications or MTC types. A terminal may host one or multiple MTC Applications. Further, the application delay may be FR1 dependent or FR2 dependent. FR1 defines bands in the sub-6 GHz spectrum (i.e., a maximum at about 7125 MHz) and FR2 defines bands in the mm Wave spectrum. Because of the higher carrier frequencies in FR2, it has a higher maximum bandwidth. Bandwidths include 5-100 MHz (FR1) and 50/100/200/400 MHz (FR2).

The application delay may be (pre-)configured or pre-defined in the standards specifications. Further, the application delay may be reported by a terminal via UE capability reporting. In some embodiments, the application delay may be different depending on whether the target cell 730 is active, inactive, or dormant. There may be a gap defined during which the terminal does not perform any transmission or reception on the source cell 720 or the target cell 730.

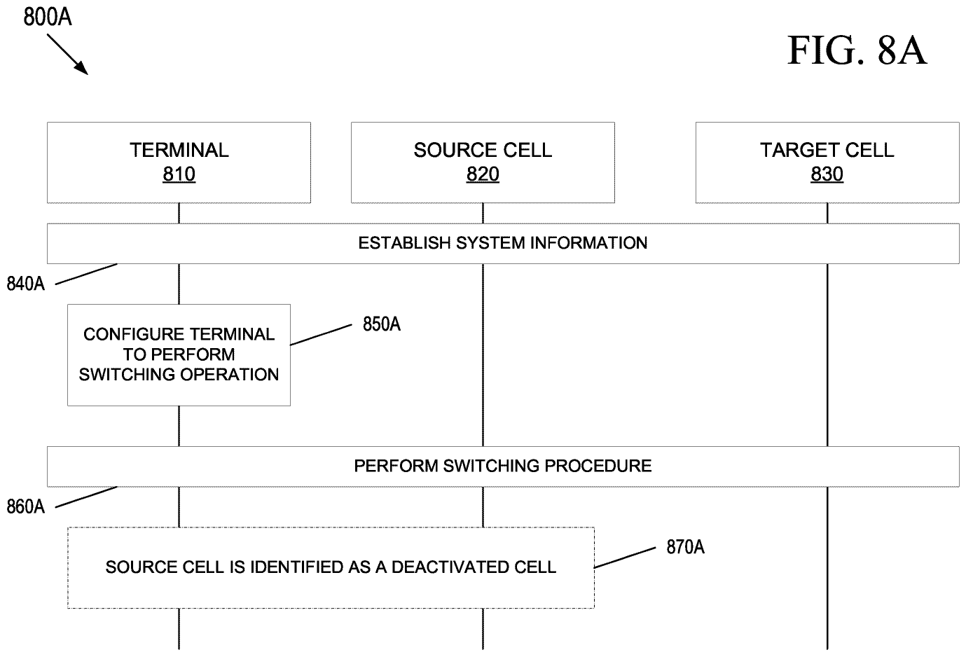

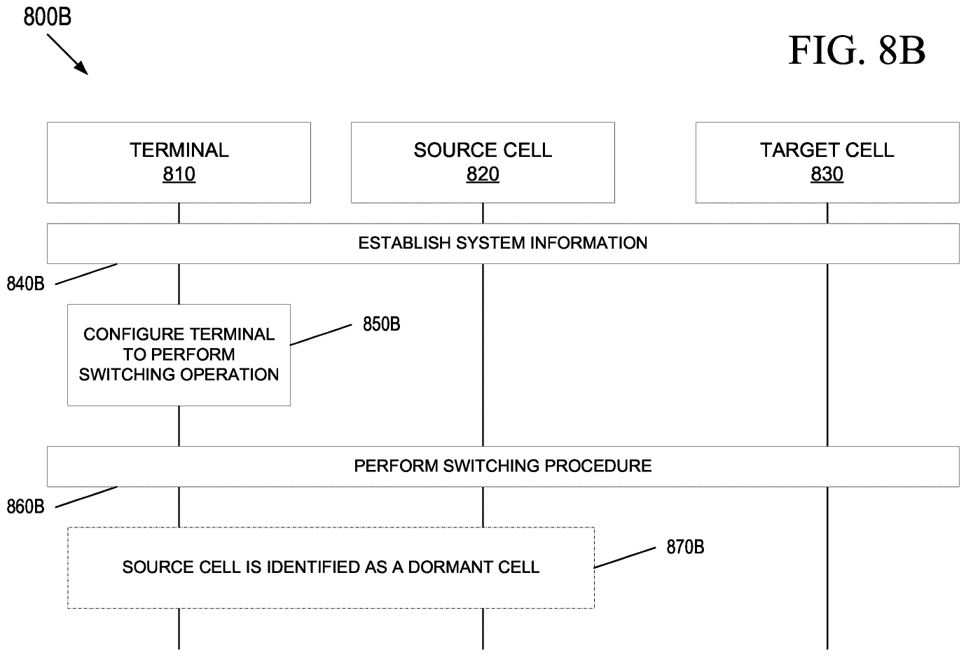

Turning to FIGS. 8A and 8B, signal diagrams 800A and 800B illustrate multiple signal exchanges in the process of providing a dynamic cell switching command to a terminal 810. In the signal diagrams 800A and 800B, the source cell 820 and the target cell 830 are connected to the terminal 810 via an established system information. In the examples of FIGS. 8A and 8B, a processor in the terminal 810 may configure the terminal 810 to perform the cell switching procedure, as shown in block 850A of FIG. 8A and block 850B of FIG. 8B.

In the examples of FIGS. 8A and 8B, the terminal 810, the source cell 820, and the target cell 830 establish system information 840 (i.e., individually labeled 840A and 840B in FIGS. 8A and 8B, respectively), where the source cell 820 or the target cell 830 indicate a specific resource allocation to the terminal 810. The system information 840 may include information used to configure data/control transmissions between the terminal 810 and multiple candidate primary cells. For example, the system information 840 may indicate that one of the source cell 820 and the target cell are configured to transmit a DCI indicating the dynamic cell switching. Further, the terminal 810 may be configured to perform the cell switching procedure 860 (i.e., individually labeled 860A and 860B in FIGS. 8A and 8B, respectively). Following the configuration in the established system information 840.

In FIG. 8A, the terminal 810, the source cell 820, and the target cell 830 establish system information 840A. Further, the terminal 810 is configured to perform the cell switching procedure, as shown in block 850A. In block 870A, after the cell switching procedure is completed, the source cell 820 is deemed a deactivated cell from the perspective of the terminal 810.

In FIG. 8B, the terminal 810, the source cell 820, and the target cell 830 establish system information 840B. Further, the terminal 810 is configured to perform the cell switching procedure, as shown in block 850B. In block 870B, after the cell switching procedure is completed, the source cell 820 is deemed a dormant cell from the perspective of the terminal 810.

In one or more embodiments, after the primary cell is switched, the source primary cell may be deactivated or put it in dormancy so that power saving may be increased in the perspective of the base station. In one embodiment of the example of FIG. 8A, the source cell 820 may be deactivated after the primary cell switching. In another embodiment of the example of FIG. 8A, the status of the source cell 820 may be dynamically indicated. The dynamic indication may be provided using one bit in a SCell deactivation indication field, as part of the block information that carries the primary cell switching indication discussed in reference to FIGS. 5 and 6.

In one or more embodiments, when the source primary cell is put in dormancy, the switching procedure may define whether the source cell 820 goes to dormancy after the primary cell switching. In one embodiment of the example of FIG. 8B, the source cell 820 may be put in dormancy after the primary cell switching. In another embodiment of the example of FIG. 8B, the status of the source cell 820 may be dynamically indicated. The dynamic indication may be provided using one bit in a SCell dormancy indication field, as part of the block information that carries the primary cell switching indication discussed in reference to FIGS. 5 and 6.

In some embodiments, the terminal 810 may reuse a same approach as in the SCell dormancy indication field in DCI format 2_6, where the SCell dormancy is indicated for all the cells in a configured dormancy cell group, with one bit per dormancy cell group. In this regard, the definition of the dormancy cell group may be extended to include the primary cell and all the primary cell candidates, because primary cell may be dynamically switched in the manner configured in FIGS. 5-7B, and each of the primary cell candidates may become a SCell depending on the application.

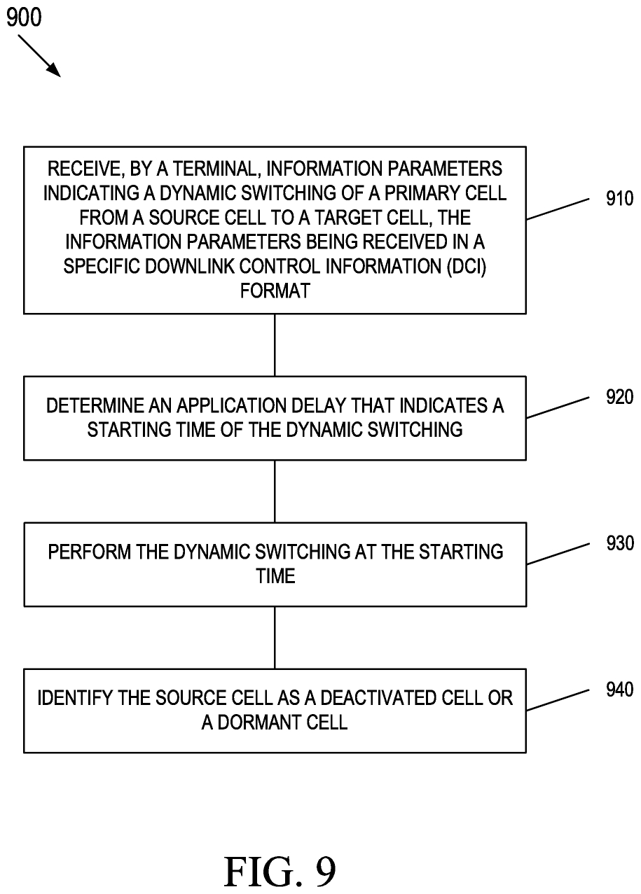

FIG. 9 illustrates a flowchart in which method 900 is performed in a sequence of blocks. The method 900 may be performed by a terminal transmitting or receiving communications with one or more cells in a cell group, in accordance with one or more embodiments. At 910, the flowchart begins with a terminal configured to receive information parameters indicating a dynamic switching of a primary cell from a source cell to a target cell. As described above, the information parameters may be received in a specific DCI format. The DCI format may be one of the DCI formats described in reference to FIGS. 5 or 6. Further, the DCI formats may be modified to include information elements and signaling discussed in 3GPP TS 38.212.

At 920, the flowchart continues with the terminal configured to determine an application delay that indicates a starting time of the dynamic switching. In some embodiments, the application delay may be defined as an offset relative to the reference time. The unit may be the number of symbols/slots or absolute time such as milliseconds. As described above, The application delay may define a starting time for the terminal 710 to use the target cell 730 as the primary cell for operation. The application delay may be used by the terminal 710 to perform the primary cell switching procedure.

At 930, the flowchart continues with the terminal configured to perform the dynamic switching at the starting time. As described above, the starting time may be calculated to allow transmission/reception after/before a reference time. The reference time for the application delay may be a time when the group common DCI is transmitted, or when an acknowledgement is transmitted.

The flowchart ends at 940 where the terminal identifies the source cell as a deactivated cell or a dormant cell. As shown in FIGS. 8A and 8B, the terminal 810 may be configured to identify the source cell as a deactivated cell or a dormant cell to increase overall energy savings in the network.

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A terminal comprising:
a receiver configured to receive information parameters indicating a dynamic switching of a primary cell from a source cell to a target cell, the information parameters being received in a specific downlink control information (DCI) format; and
a processor configured to:
determine an application delay that indicates a starting time of the dynamic switching, and
use the target cell as the primary cell at the starting time.

2. The terminal of claim 1, wherein:
a first DCI format comprises a plurality of information blocks carrying information related to the primary cell switching for the terminal and at least one additional primary cell switching for another terminal.

3. The terminal of claim 2, wherein:
a second DCI format comprises one information block carrying information related to the primary cell switching for the terminal and at least one information block for a purpose other than primary cell switching for a terminal.

4. The terminal of claim 1, wherein:
the information block comprises at least one or more of a primary cell index, a Physical Uplink Control Channel (PUCCH) resource for transmitting the indication acknowledging that the information parameters were received, a time offset for transmission of the PUCCH resource, or an indication of the application delay.

5. The terminal of claim 4, wherein:
the primary cell index comprises a non-zero index or a zero index.

6. The terminal of claim 1, further comprising:
a transmitter configured to transmit, to the source cell or the target cell, an indication acknowledging that the information parameters were received.

7. The terminal of claim 6, wherein:
the indication acknowledging that the information parameters were received is transmitted in a Physical Uplink Control Channel (PUCCH) configured for the source cell or a PUCCH configured for the target cell.

8. The terminal of claim 1, wherein:
the source cell is identified as the deactivated cell or the dormant cell after dynamic switching by an indication parameter in the specific DCI format.

9. The terminal of claim 1, wherein:
the specific DCI format is a group common DCI format.

10. The terminal of claim 1, wherein the processor is further configured to:
identify the source cell as a deactivated cell or a dormant cell after the primary cell switching.

11-17. (canceled)

18. An integrated circuit configured to cause a wireless device to perform the following operations:
receive, at a receiver of the wireless device, information parameters indicating a dynamic switching of a primary cell from a source cell to a target cell, the information parameters being received in a specific downlink control information (DCI) format;
determine an application delay that indicates a starting time of the dynamic switching; and
use the target cell as the primary cell at the starting time.

19. The integrated circuit of claim 18, wherein:
a first DCI format comprises a plurality of information blocks carrying information related to the primary cell switching for the wireless device and at least one additional primary cell switching for another wireless device.

20. The integrated circuit of claim 19, wherein:
a second DCI format comprises one information block carrying information related to the primary cell switching for the wireless device and at least one information block for a purpose other than primary cell switching for a wireless device.

21. The integrated circuit of claim 18, wherein:
the information block comprises at least one or more of a primary cell index, a Physical Uplink Control Channel (PUCCH) resource for transmitting the indication acknowledging that the information parameters were received, a time offset for transmission of the PUCCH resource, or an indication of the application delay.

22. The integrated circuit of claim 21, wherein:
the primary cell index comprises a non-zero index or a zero index.

23. A method, comprising:
receiving, at a receiver of a wireless device, information parameters indicating a dynamic switching of a primary cell from a source cell to a target cell, the information parameters being received in a specific downlink control information (DCI) format;
determining an application delay that indicates a starting time of the dynamic switching; and
using the target cell as the primary cell at the starting time.

24. The method of claim 21, further comprising:
transmitting, with a transmitter of the wireless device, to the source cell or the target cell, an indication acknowledging that the information parameters were received.

25. The method of claim 24, wherein:
the indication acknowledging that the information parameters were received is transmitted in a Physical Uplink Control Channel (PUCCH) configured for the source cell or a PUCCH configured for the target cell.

26. The method of claim 21, wherein:
the source cell is identified as the deactivated cell or the dormant cell after dynamic switching by an indication parameter in the specific DCI format.

27. The method of claim 21, further comprising:
identifying the source cell as a deactivated cell or a dormant cell after the primary cell switching.
